(19) United States
(12) Patent Application Publication
(10) Pub. No.: US 2016/0379178 A1
(43) Pub. Date: Dec. 29, 2016

(54) INSPECTION RESULT UPDATE CONTROL METHOD, INSPECTION RESULT STORAGE CONTROL METHOD, INSPECTION RESULT UPDATE CONTROL SYSTEM, AND INSPECTION RESULT STORAGE CONTROL SYSTEM

(71) Applicant: FUJITSU LIMITED, Kawasaki-shi (JP)

(72) Inventors: Yuta SHIOIRI, Kawasaki (JP); Masaki KURODA, Kita (JP); Yoko SAITO, Kawasaki (JP); Toshiyuki MARUYAMA, Kawasaki (JP); Iwao KAKEGAWA, Kawasaki (JP)

(73) Assignee: FUJITSU LIMITED, Kawasaki-shi (JP)

(21) Appl. No.: 15/263,481

(22) Filed: Sep. 13, 2016

Related U.S. Application Data
(63) Continuation of application No. PCT/JP2014/059160, filed on Mar. 28, 2014.

(51) Int. Cl. G06Q 10/00

(52) U.S. Cl. CPC G06Q 10/20

(57) ABSTRACT

An inspection result update control method includes performing control to accept updating an inspection result of an inspection subject included in an inspection set from a first terminal having initially downloaded data for inputting inspection results of the inspection set and control to restrict updating an inspection result of the inspection subject from a second terminal when the data for inputting the inspection results of the inspection set are downloaded, the inspection subjects being inspected in a predefined inspection order; and performing control to accept updating an individual inspection result of an inspection subject from the first terminal having initially downloaded data for inputting individual inspection results of the individual inspection subjects as well as accepting updating an individual inspection result of the individual inspection subject from the second terminal when data for inputting the individual inspection results of the individual inspection subjects are downloaded.

### CROSS-REFERENCE TO RELATED APPLICATIONS

This application is a continuation application of International Application PCT/JP2014/059160 filed on Mar. 28, 2014 and designated the U.S., the entire contents of which are incorporated herein by reference.

### FIELD

The disclosures discussed herein relate to an inspection result update control method, an inspection result storage control method, an inspection result update control system, and an inspection result storage control system.

### BACKGROUND

There are systems for assisting facility inspection work conducted in plants or the like known in the art. In such systems, various types of accompanying information including inspection results input in terminal apparatuses may be uploaded to servers in association with pointers indicating inspection parts in inspection routes illustrated in a map. In addition, there is also known in the art a technology to determine whether to allow uploading from a user's terminal to a server.

In the above-described related art systems, inspections performed with respect to pointers include a type of inspection allowable to receive uploading of inspection results from two or more users and a type of inspection allowable to receive uploading of an inspection from only one user. In such a case, the systems need to update the inspection results in accordance with the types of the inspections in order to prevent mismatch of data in the inspection results.

### RELATED-ART DOCUMENT

### Patent Document

Patent Document 1: Japanese Laid-open Patent Publication No. 2003-99312

### SUMMARY

According to an aspect of an embodiment, there is provided an inspection result update control method that includes performing control to accept updating an inspection result of an inspection subject included in an inspection set from a first terminal that has initially downloaded data for use in inputting inspection results of the inspection set, the inspection set including a plurality of inspection subjects, and performing control to restrict updating an inspection result of the inspection subject from a second terminal when the data for use in inputting the inspection results of the inspection set including the plurality of the inspection subjects are downloaded, the plurality of inspection subjects being inspected in a predefined inspection order; and performing control to accept updating an individual inspection result of an individual inspection subject included in individual inspection subjects from the first terminal that has initially downloaded data for use in inputting individual inspection results of the individual inspection subjects, as well as accepting updating an individual inspection result of the individual inspection subject included in the individual inspection subjects from the second terminal when data for use in inputting the individual inspection results of the individual inspection subjects are downloaded.

The object and advantages of the invention will be realized and attained by means of the elements and combinations particularly pointed out in the appended claims.

It is to be understood that both the foregoing general description and the following detailed description are exemplary and explanatory and are not restrictive of the invention as claimed.

### BRIEF DESCRIPTION OF DRAWINGS

FIG. 1 is a diagram illustrating a system configuration example of an inspection result update control system;

FIG. 2 is a diagram illustrating an example of a pin definition database;

FIG. 3 is a diagram illustrating an example of a pin record database;

FIG. 4 is a diagram illustrating an example of a route definition database;

FIG. 5 is a diagram illustrating an example of a route record database;

FIG. 6 is a diagram illustrating an example of a map definition database;

FIGS. 7A to 7C are diagrams illustrating layers of a map;

FIG. 8 is a diagram illustrating an example of an attachment database;

FIG. 9 is a diagram illustrating a hardware configuration example of a server;

FIG. 10 is a diagram illustrating functional configurations of a terminal apparatus and the server included in the inspection result update control system;

FIG. 11 is a flowchart illustrating a cyclic inspection process performed by the terminal apparatus;

FIG. 12 is a flowchart illustrating an individual inspection process performed by the terminal apparatus;

FIG. 13 is a flowchart illustrating a download process from the server to the terminal apparatus;

FIG. 14 is a flowchart illustrating an upload process from the terminal apparatus to the server;

FIGS. 15A and 15B are diagrams illustrating a download process from the server to the terminal apparatus;

FIG. 16 is a diagram illustrating another example of the pin record database; and

FIGS. 17A and 17B are diagrams illustrating adding a new pin.

### DESCRIPTION OF EMBODIMENTS

Hence, it is desirable to provide a fuse and an RFID tag capable of being read when the temperature rises.

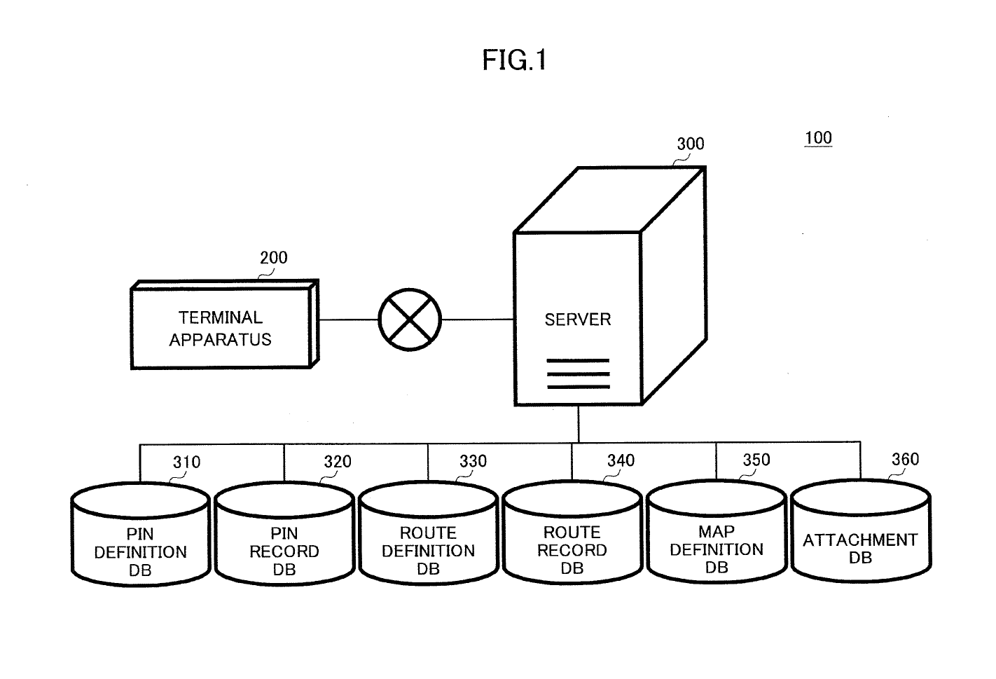

According to an aspect of embodiments, it is desirable to provide a technology to control updating of inspection results according to on-site operations. The following illustrates embodiments of the present invention with reference to the accompanying drawings. FIG. 1 is a diagram illustrating a system configuration example of an inspection result update control system 100.

The inspection result update control system 100 (hereinafter simply referred to as an “update control system 100”) includes a terminal apparatus 200 and a server 300 that are connected via a network.

The update control system 100 according to an embodiment is configured to assist inspection work of various types of facilities conducted by inspection workers within plants such as factories and electric generation plants.

The server 300 of an embodiment includes a pin definition database (DB) 310, a pin record database (DB) 320, a route definition database (DB) 330, a route record database (DB) 340, a map definition database (DB) 350, and an attachment database (DB) 360.

The terminal apparatus 200 of the embodiment is configured to assist inspection work upon activation of an inspection assisting program executed by an inspection worker. More specifically, the terminal apparatus 200 refers to the pin definition DB 310, the route definition DB 330, and the map definition DB 350, and displays pointers (hereinafter referred to as “pins”) indicating inspection parts based on an inspection route illustrated in a map. The terminal apparatus 200 also refers to the pin definition DB 310, and displays an input screen having entry fields for inputting items related to a pin to prompt the inspection worker to input inspection result values in the items of the entry fields. The terminal apparatus 200 assists the inspection work in the above-described manner.

When the terminal apparatus 200 receives inspection result values input for all the pins included in the inspection route, the terminal apparatus 200 transmits the inspection results to the server 300 to store the inspection results in the pin record DB 320 and the route record DB 340. Note the in the following embodiments, an inspection result may represent a collection of the inspection result values input via the input screen corresponding to the pins.

When the terminal apparatus 200 receives files such as images or documents associated with the pins, the terminal apparatus 200 transmits these files to the server 300 to store the files in the attachment DB 360 as attachment information associated with the pins. In this embodiment, such files are called attachment files corresponding to respective pins.

The pin inspection in the update control system 100 includes a cyclic inspection performed in accordance with a predetermined inspection order determined along an inspection route, and an individual inspection performed on individual pins separately from the cyclic inspection.

The cyclic inspection is designed for one user (hereinafter called an “inspection worker”) to perform inspection on predetermined inspection items in relation to one inspection route. In view of conducting efficient inspection work, it is not common for two or more inspection workers to simultaneously perform inspection on an identical pin. Accordingly, it may be preferable to receive registering or updating of the inspection result of the cyclic inspection from one inspection worker who currently conducts the cyclic inspection.

By contrast, the individual inspection may be simultaneously performed on an identical pin by two or more inspection workers. Accordingly, it may be preferable to receive registering or updating of the inspection result of the individual inspection from two or more inspection workers.

This embodiment focuses upon characteristics of the cyclic inspection and the individual inspection for updating the inspection results in accordance with inspection operation-sites.

More specifically, when data for use in inputting inspection result of the cyclic inspection are downloaded from the terminal apparatus 200, the server 300 restricts updating of the inspection result of the cyclic inspection from terminal apparatuses other than the terminal apparatus 200. In addition, when data for use in inputting inspection result of the individual inspection are downloaded from the terminal apparatus 200, the server 300 allows terminal apparatuses other than the terminal apparatus 200 to update the inspection results of the individual inspection.

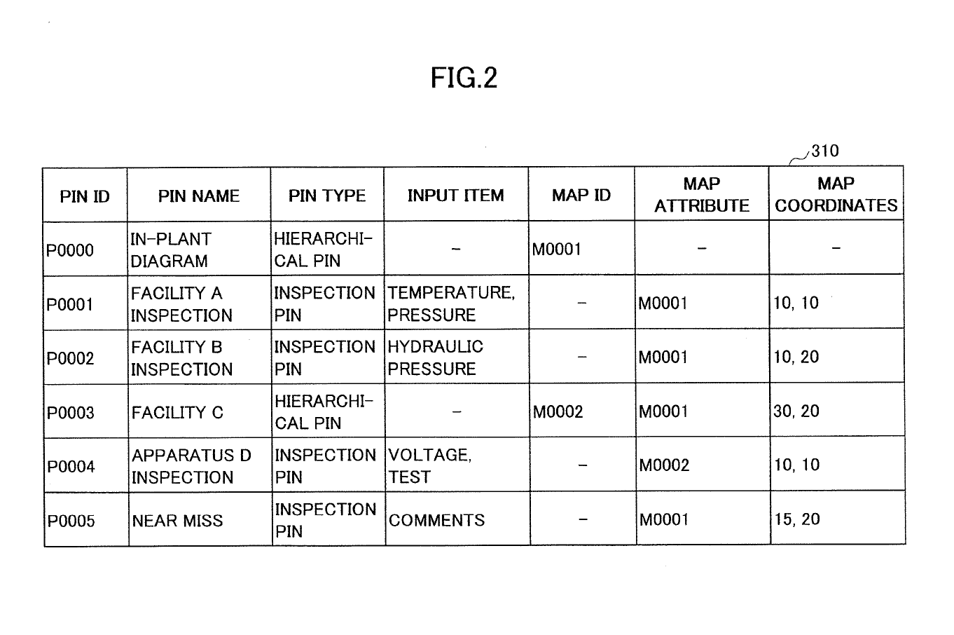

The following illustrates respective databases included in the server 300 according to the embodiment with reference to FIGS. 2 to 8.

FIG. 2 is a diagram illustrating an example of the pin definition DB 310.

The pin definition DB 310 according to an embodiment includes a pin ID stored in association with a pin name, a pin type, an input item, a map ID, a map belonging, and map coordinates. In the following illustration, information items in association with the pin ID as a key in the pin definition DB 310 may be called “pin information”.

The pin ID is an identifier for identifying a pin. The pin name is a name of the pin. The pin type indicates a type of the pin. In this embodiment, there are two types of pins including a hierarchical pin and an inspection pin. The hierarchical pin illustrates a layer in the later-described map. The inspection pin illustrates an inspection part in the later-described map.

In the following description, layer types of pins are simply called “hierarchical pins” and inspection types of pins are simply called “inspection pins”.

The input items in an entry field correspond to items to be input as the inspection results obtained in the inspection work. In this embodiment, the input items are associated with the inspection pins such that the input items are determined corresponding to the pins.

The map IDs are associated with the hierarchical pins, and each map ID indicates a map of a layer indicated by the corresponding one of the hierarchical pins. The map affiliates are associated with the inspection pins and the hierarchical pins, and the map affiliate indicates a map including the inspection pins and the hierarchical pins. The map coordinates are associated with the inspection pins, and the map coordinates indicate a position of the inspection pin in the map including the inspection pin.

In the example of FIG. 2, a pin having the pin ID “P0000” is the hierarchical pin having the pin name “in-plant diagram”. The hierarchical pin having the pin ID “P0000” is associated with the map ID “M0001”. In the example of FIG. 2, a pin having the pin ID “P0001” is the inspection pin having the pin name “facility A inspection”. The inspection pin ID having the pin ID “P0001” has input items “temperature” and “pressure”, and is positioned at coordinates (10, 10) in the map having the map ID “M0001”.

In FIG. 2, a pin having the pin ID “P0003” is the hierarchical pin having the pin name “facility C”. The hierarchical pin having the pin ID “P0003” belongs to the map having the map ID “M0001”, is positioned at coordinates (30, 20), and associated with the map ID “M0002”. That is, the hierarchical pin “P0003” defines a layer connected from the map ID “M0001” to the map ID “0002”.

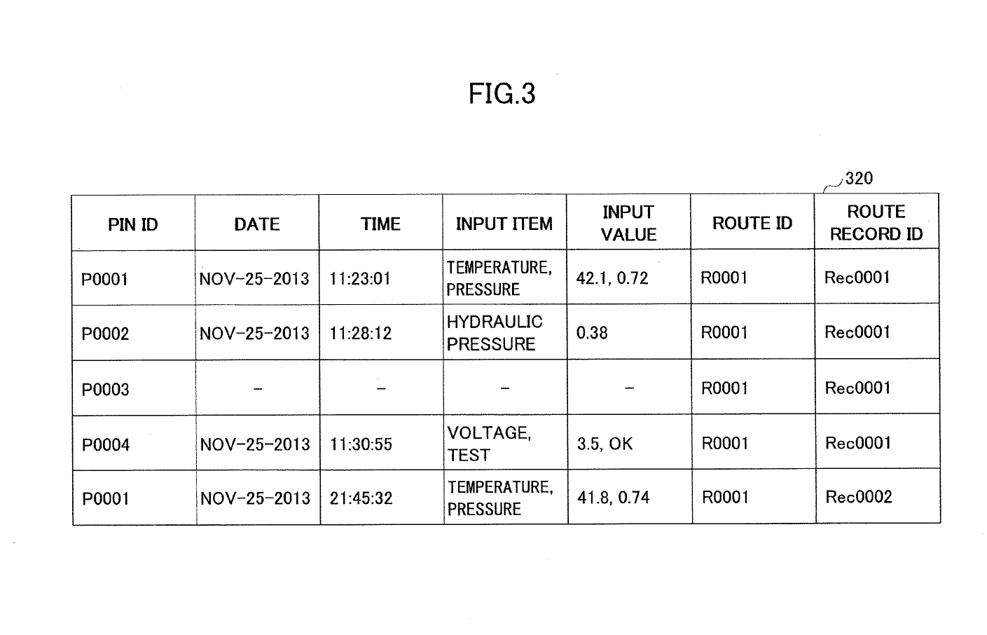

FIG. 3 is a diagram illustrating an example of the pin record database (DB) 320.

The pin record DB 320 according to the embodiment is configured to store an inspection result for each of the inspection pins.

The pin record DB 320 includes the pin ID as a key in association with a date, a time, an input item, an input value, a route ID, and a route record ID as other information items. In the following illustration, information items in association with the pin ID as a key in the pin record DB 320 may be called “pin record information”.

In the pin record DB 320, the date and the time indicate date and time at which an input value is input into the input item. The input items are associated with the inspection pins, and the input values are input in association with the input items.

The route ID is an identifier for identifying the inspection route including the inspection pins. The route record ID is an identifier for identifying an inspection result of each of the inspection routes.

In the example of FIG. 3, as the inspection result corresponding to the inspection pin having the pin ID “0002”, the input value “0.38” is input in the entry field corresponding to the input item “hydraulic pressure” in association with the date “Nov-25-2013” and the time “11:23:01”. The inspection pin having the pin ID “P0002” is included in the inspection route identified by the route ID “R0001”, and the inspection result of the inspection pin having the pin ID “P0002” is included in the route record identified by the route record ID “Rec0001”.

The example of FIG. 3 does not include an input item corresponding to a hierarchical pin having a pin ID “P0003”. The hierarchical pin having a pin ID “P0003” does not have any newly updated data and hence there is no item input as the inspection result for the hierarchical pin having a pin ID “P0003”.

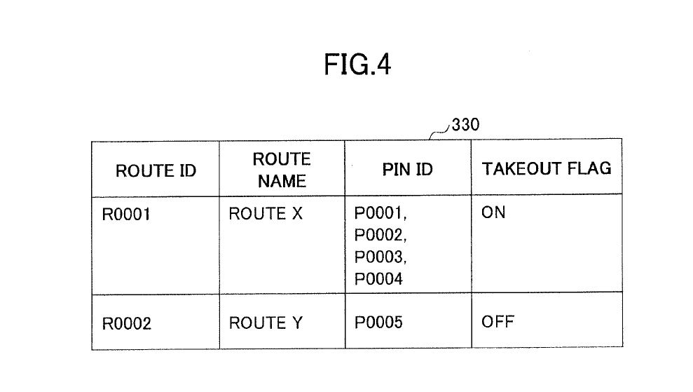

FIG. 4 is a diagram illustrating an example of the route definition database (DB) 330.

The route definition DB 330 according to an embodiment includes a route ID as a key in association with a route name, a pin ID, and a takeout flag as other items. In the following illustration, information items in association with the route ID as a key in the route definition DB 330 may be called “route information”.

In the route definition DB 330, the route ID is in association with the pin IDs, indicating that respective pins indicated by the pin IDs are included in the inspection route indicated by the route ID. The two or more pins included in the inspection route is called an inspection set. The takeout flag indicates whether the terminal apparatus 200 has downloaded the inspection route indicated by the route ID. In the example of FIG. 4, the takeout flag corresponding to the route ID “R0001” indicates “ON”. The “ON” of the takeout flag indicates that the terminal apparatus 200 has downloaded the inspection route indicated by the route ID “R0001”. The takeout flag corresponding to the route ID “R0002” indicates “OFF”. The “ODD” of the takeout flag indicates that the terminal apparatus 200 has not downloaded the inspection route indicated by the route ID “R0002”.

In the example of FIG. 4, the inspection route having the route ID “R0001” and the route name “route X” includes inspection pins having the pin IDs “P0001”, “P0002” and “P0004”, and the hierarchical pin having the pin ID “P0003”.

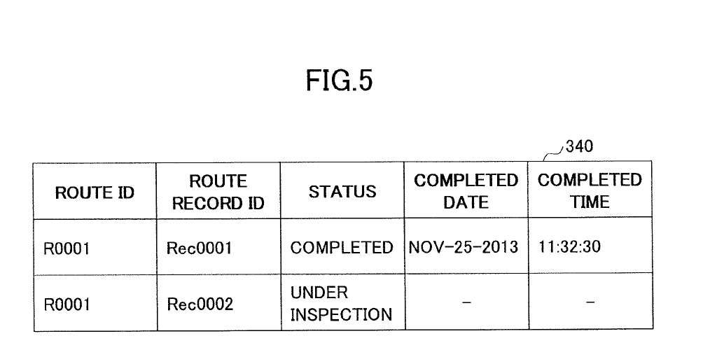

FIG. 5 is a diagram illustrating an example of the route record database (DB) 340.

The route record DB 340 according to an embodiment includes the route ID as a key in association with a route record ID, a status, a completed date, and a completed time as the other information items. In the following illustration, information items in association with the route ID as a key in the route record DB 340 may be called “route record information”.

The status in the route record DB 340 indicates an inspection work status of the inspection route indicated by the route ID. The completed date and completed time indicate date and time at which the inspection work of the inspection route indicated by the route ID has been completed.

In the example of FIG. 5, the inspection result of the inspection route having the route ID “R0001” is recorded as a route record ID “Rec0001”, and indicates that the inspection work has been completed at 11:32:30 on Nov. 25, 2013.

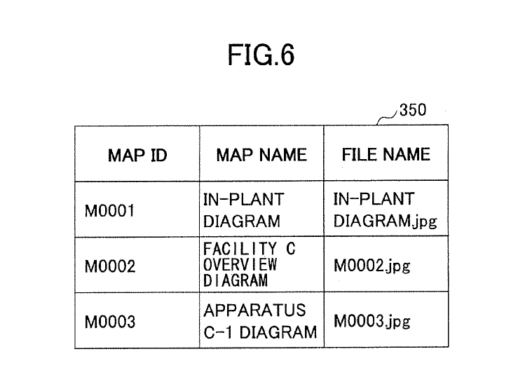

FIG. 6 is a diagram illustrating an example of the map definition database (DB) 350.

The map definition DB 350 according to an embodiment includes the map ID as a key in association with a map name and a file name as the other information items. In the following illustration, information items in association with the map ID as a key in the map definition DB 350 may be called “map information”.

The map name is a name of a map, and the file name is a name of a file used for displaying the map on the terminal apparatus 200.

In the example of FIG. 6, the map name identified by the map ID “M0001” is “in-plant diagram”, and a file used for displaying the map is “in-plant.jpg”.

In the map definition DB 350 of the embodiment may include a file illustrating an overall area subject to inspection such as a factory, a file indicating facility subject to inspection work, and a file indicating an apparatus within the facility subject to inspection, as different layers of the map.

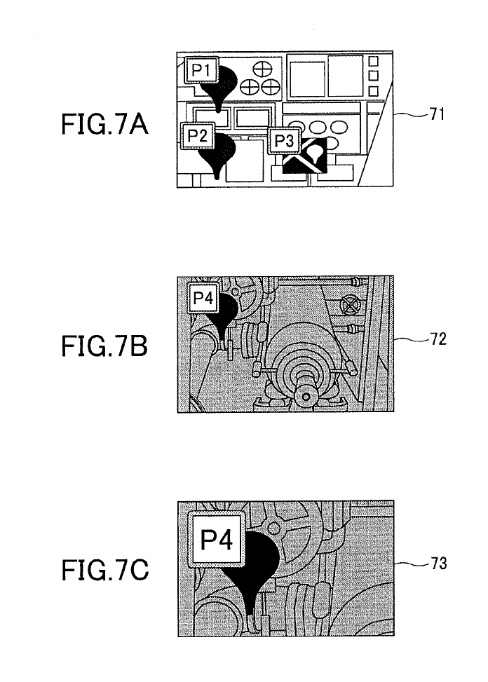

In the following, a description is given of layers of the map with reference to FIGS. 7A to 7C. FIGS. 7A to 7C are diagrams illustrating the layers of the map. More specifically, FIG. 7A illustrates an example of a first layer of the map, FIG. 7B illustrates an example of a second layer of the map, and FIG. 7C illustrates an example of the map enlarging a part subject to inspection of the second layer of the map.

FIG. 7A indicates a map 71 illustrating an area in which the facilities are disposed. The map 71 may be the in-plant diagram of the map having the map ID “M0001” registered in the map definition DB 350. The map 71 illustrates a hierarchical pin P3, an inspection pin P1, and an inspection pin P2. In this embodiment, it may be preferable to display the hierarchical pin and the inspection pins on the map with corresponding icon images based on the types of the pins.

FIG. 7B indicates a map 72 illustrating a lower layer of the map 71 including an outline of the facility in an area indicated by the hierarchical pin P3 of the map 71. That is, the map 72 illustrates particulars of the area indicated by the hierarchical pin P3 in the map 71. The map 72 may be the in-plant diagram of the map having the map ID “M0001” registered in the map definition DB 350. The map 72 displays an inspection pin P4. The inspection pin P4 indicates an apparatus subject to inspection within the facility displayed as the map 72.

FIG. 7C illustrates a map 73 displaying a part enlarging the inspection part of the map 72. FIG. 7C illustrates a layout of the apparatus subject to inspection indicated by the inspection pin P4.

That is, the lower the layer, the more detailed is the image of the inspection part displayed on the terminal apparatus 200 in this embodiment. In this embodiment, a relationship between the layers of the map stored in the map definition DB 350 may be indicated by the pins in association with the map and the inspection route including the pins.

The map definition DB 350 of the embodiment may include file names of the maps (e.g., image data) for displaying the map 71, the map 72, and the map 73 stored in association with the map IDs and the map names. In this embodiment, entities of the files for displaying the respective maps may be stored in the map definition DB 350, or the entities of the files may be stored in a different storage device.

The map definition DB 350 may include the map IDs in association with information indicating relationships between the layers of the maps. More specifically, the map immediately beneath the map having the map ID “M0001” corresponds to a map having the map ID “M0002”. Thus, the map ID “M0002” may be associated with information “M0002” may be associated with information indicated by, for example, a map ID “M0001-1” indicating a map that is one layer beneath the map having the map ID “M0001”.

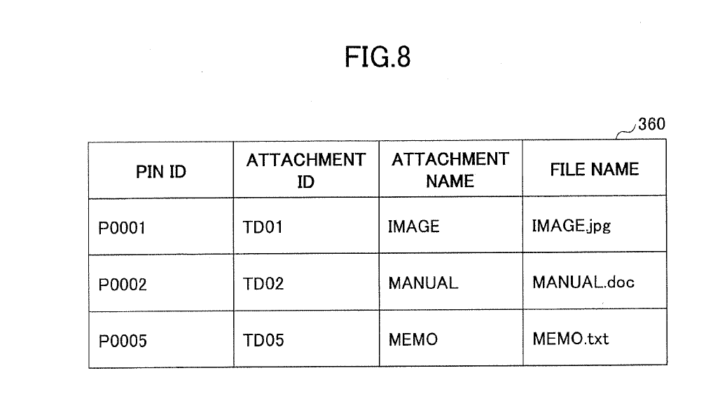

FIG. 8 is a diagram illustrating an example of the attachment DB 360. The attachment DB 360 according to an embodiment includes a pin ID as a key in association with an attachment ID, an attachment name, and a file name as other items. In the following illustration, information items in association with the pin ID as a key in the attachment DB 360 may be called “attachment information”.

The attachment ID is information identifying an attachment file attached to the pin corresponding to the pin ID. The attachment name is a name of an attachment file, and the file name is a name of a file used for displaying the attachment file on the terminal apparatus 200.

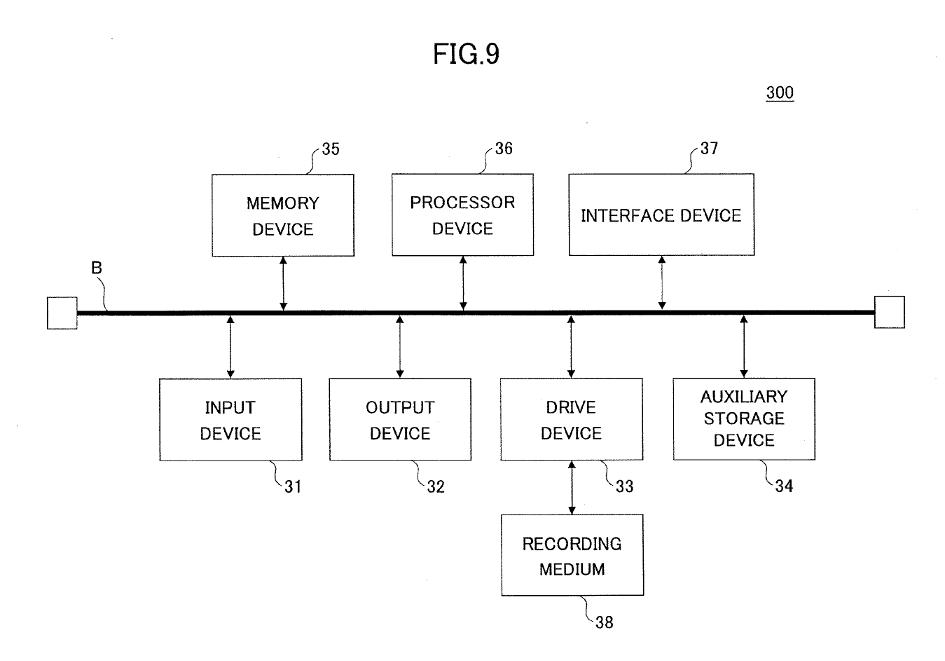

FIG. 9 is a diagram illustrating a hardware configuration example of the server 300 according to an embodiment. The server 300 includes an input device 31, an output device 32, a drive device 33, an auxiliary storage device 34, a memory device 35, a processor 36, and an interface device 37, which are connected to one another via a bus B.

The input device 31 includes a keyboard and a mouse, and is configured to input various types of signals. The output device 32 includes a display device, and is configured to display various types of windows or data. The interface device 37 may include a modem and a LAN card, and is configured to connect the server 300 to the network N.

An inspection result update control program 380 (hereinafter called an “update control program 380”) described later may at least be a part of various types of programs controlling the server 300. The update control program 380 may be provided by being distributed in a form of a recording medium 38 or downloaded from the network. Note that various types of recording media may be used as the recording medium 38 storing the update control program 380, examples of which include a compact disk read-only memory (CR-ROM), a flexible disk, and a magneto-optical disk, or semiconductor memory or the like electrically recording information such as a read-only memory (ROM), a flash memory or the like.

When the recording medium 38 storing the update control program 380 is set in the drive device 33, the update control program 380 is installed from the recording medium 38 into the auxiliary storage device 34 via the drive device 33. When the update control program 380 is downloaded via the network, the downloaded update control program 380 is installed into the auxiliary storage device 34 via the interface device 37.

The auxiliary storage device 34 is configured to store the update control program 380 as well as storing necessary files, data, and the like. The memory device 35 is configured to read the update control program 380 from the auxiliary storage device 34 and store the read update control program 380 at the startup of a computer. The processor 36 is configured to execute later-described various types of processes in accordance with the update control program 380 stored in the memory device 35.

The terminal apparatus 200 according to an embodiment is a computer having a hardware configuration similar to that of the server 300, and a duplicated illustration of the hardware configuration is thus omitted from the specification. The terminal apparatus 200 of the embodiment may be a tablet computer. The terminal apparatus 200 of the embodiment may be a multifunctional mobile phone including a smartphone.

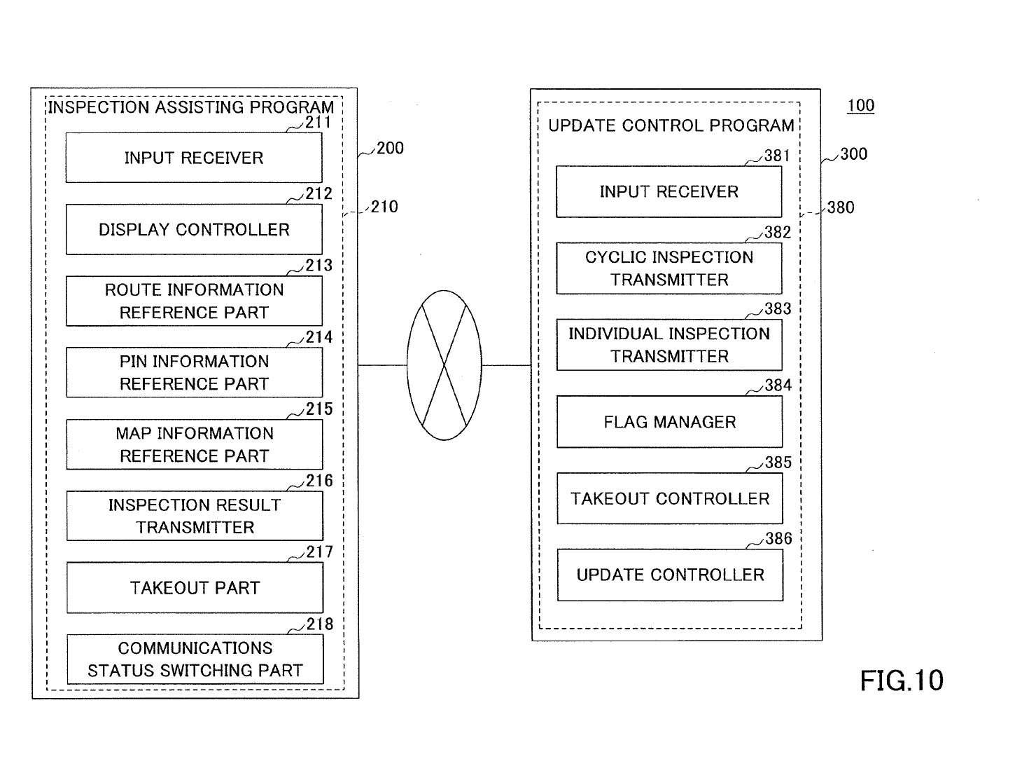

The following illustrates, with reference to FIG. 10, functional configurations of the terminal apparatus 200 and the server 300 included in the update control system 100 according to an embodiment. FIG. 10 is a diagram illustrating functional configurations of the terminal apparatus 200 and the server 300 included in the update control system 100.

The terminal apparatus 200 according to the embodiment has an inspection assisting program 210 installed therein. The terminal apparatus 200 of the embodiment executes the inspection assisting program 210 to implement later-described processes of the terminal apparatus components.

The terminal apparatus 200 according to the embodiment includes an input receiver 211, a display controller 212, a route information reference part 213, a pin information reference part 214, a map information reference part 215, an inspection result transmitter 216, a takeout part 217, and a communications status switching part 218.

The input receiver 211 is configured to receive inputs by operations of a display operations apparatus included in the terminal apparatus 200. The display controller 212 is configured to control display of the display operations apparatus included in the terminal apparatus 200.

The route information reference part 213 is configured to refer to route information in the route definition DB 330, based on an input received by the input receiver 211. The pin information reference part 214 is configured to refer to pin information in the pin definition DB 310, based on an input received by the input receiver 211. The map information reference part 215 is configured to refer to map information in the map definition DB 350, based on a map ID included in the pin information.

The inspection result transmitter 216 is configured to transmit an inspection result to the server 300 when the inspection work of the inspection route has been completed.

The takeout part 217 is configured to acquire the route information and pin information from the server 300, and store the acquired route information and pin information to maintain the stored route information and pin information. That is, the takeout part 217 downloads from the server 300 information necessary for the cyclic inspection and the individual inspection.

The communications status switching part 218 is configured to switch a communications status between the terminal apparatus 200 and the server 300. More specifically, the communications status switching part 218 switch between a communications capable status (ONLINE) and a communications incapable status (OFFLINE) in the communications between the terminal apparatus 200 and the server 300.

The server 300 according to the embodiment has an inspection result update program 380 installed therein. The server 300 of the embodiment executes the inspection result update program 380 to implement later-described processes of the server components.

The server 300 of the embodiment includes an input receiver 381, a cyclic inspection transmitter 382, an individual inspection transmitter 383, a flag manager 384, a takeout controller 385, and an update controller 386.

The input receiver 381 is configured to receive various types of inputs with respect to the server 300. The inputs received by the input receiver 381 includes various types of requests transmitted from the terminal apparatus 200.

The cyclic inspection transmitter 382 is configured to receive a download request for downloading information necessary for the cyclic inspection from the terminal apparatus 200 and transmit the corresponding information to the terminal apparatus 200. The information necessary for the cyclic inspection at least includes route definition information, map definition information, and pin definition information.

The individual inspection transmitter 383 is configured to receive a download request for downloading information necessary for the individual inspection from the terminal apparatus 200 and transmit the corresponding information to the terminal apparatus 200. The information necessary for the individual inspection at least includes pin definition information and map information.

The flag manager 384 is configured to manage takeout flags of the route definition DB 330. Specifically, the flag manager 384 sets the takeout flag “ON” corresponding to the route ID transmitted by the cyclic inspection transmitter 382 to the terminal apparatus 200. The flag manager 384 sets the takeout flag “OFF” corresponding to the route ID in the route definition DB 330 corresponding to a route ID having a status value “completed” in the route record DB 340.

The takeout controller 385 is configured to control transmission of information by the cyclic inspection transmitter 382 in accordance with a value of the takeout flag. The update controller 386 is configured to control storing of the inspection results or attachment files transmitted from the terminal apparatus 200. Detailed processes of the takeout controller 385 and the update controller 386 will be described later.

The following illustrates operations of the terminal apparatus 200 and operations of the server 300 in the update control system 100 according to the embodiment.

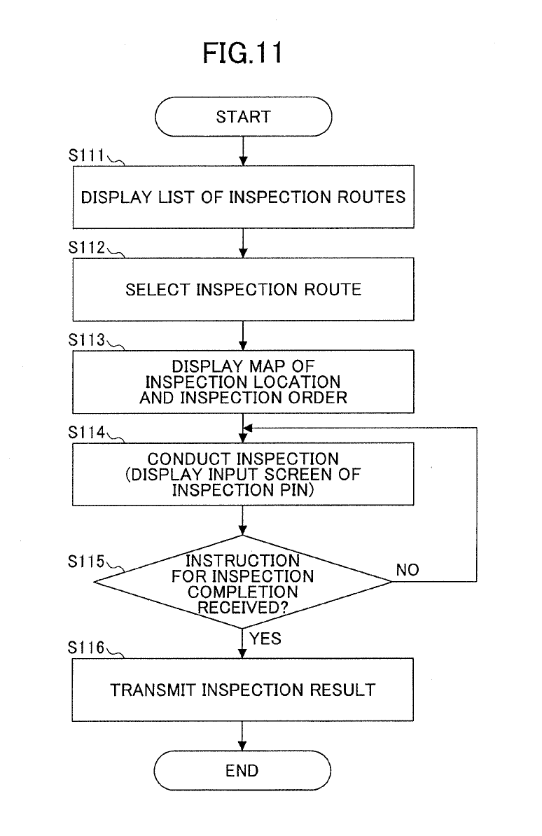

Initially, a description is given of a cyclic inspection process of the operations of the terminal apparatus 200. FIG. 11 is a flowchart illustrating a cyclic inspection process performed by the terminal apparatus 200.

In the inspection result update control system 100 according to the embodiment, when the terminal apparatus 200 receives an instruction to start cyclic inspection via the input receiver 211, the terminal apparatus 200 causes the route information reference part 213 to refer to the route definition DB 330 and causes the display controller 212 to display a list of inspection routes on a display operations apparatus 21 (step S111). The terminal apparatus 200 subsequently causes the input receiver 211 to receive selection of an inspection route (step S112).

The terminal apparatus 200 subsequently displays locations subject to inspection in the selected inspection route and an inspection order of the locations (step S113). The terminal apparatus 200 causes the route information reference part 213 to refer to the pin definition DB 310 and display an input screen of the inspection result corresponding to an inspection pin subject to inspection to assist an inspection performed by an inspection worker.

The terminal apparatus 200 subsequently determines whether an completion instruction of the inspection work has been received (step S115), and when the completion instruction has not been received, the terminal apparatus 200 returns to step S124. When the completion instruction has been received in step S115, the terminal apparatus 200 transmits the inspection result of the cyclic inspection to the server 300 (step S116).

Note that according to the embodiment, the attachment files such as images capturing the inspection parts or memos created by the inspection worker may be associated with the inspection result. In such a case, the terminal apparatus 200 transmits the inspection result and attachment file to the server 300. The server 300 causes the update controller 386 to provide the attachment ID to the transmitted attachment file and store the attachment ID in association with the pin ID of the corresponding pin in the attachment DB 360.

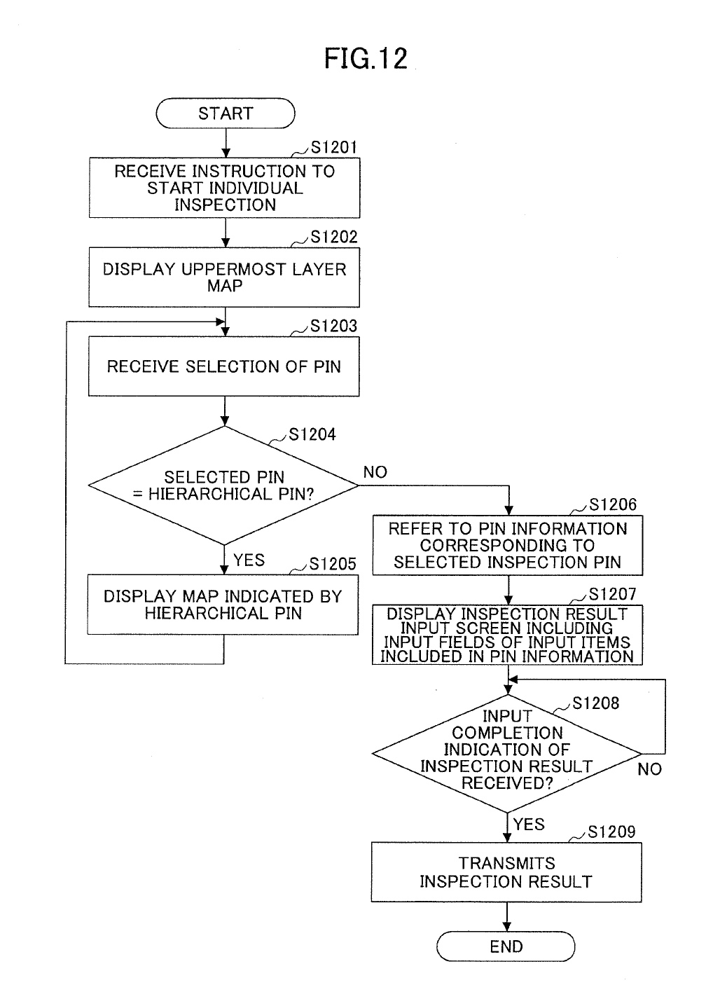

Next, a description is given of an individual inspection process of the operations of the terminal apparatus 200. FIG. 12 is a flowchart illustrating an individual inspection process performed by the terminal apparatus 200.

The terminal apparatus 200 of the embodiment causes the input receiver 211 to receive selection of an instruction to start individual inspection (step S1201). The terminal apparatus 200 subsequently causes the display controller 212 to display the uppermost layer map in the map definition DB 350 of the server 300 (step S1202). The terminal apparatus 200 subsequently causes the input receiver 211 to receive selection of a pin on the displayed map (step S1203).

The terminal apparatus 200 subsequently causes the pin information reference part 214 to refer to the pin definition DB 310 and determine whether the selected pin is a hierarchical pin (step S1204). When the pin information reference part 214 determines that the selected pin is a hierarchical pin in step S1204, the terminal apparatus 200 causes the display controller 212 to display a map indicated by the hierarchical pin (step S1205) and then return to step S1203.

When the selected pin is not a hierarchical pin in step S1204, the selected pin is an inspection pin. In this case, the terminal apparatus 200 causes the pin information reference part 214 to refer to pin information corresponding to the selected inspection pin (step S1206). The terminal apparatus 200 subsequently causes the display controller 212 to display an inspection result input screen including entry fields of input items included in the pin information (step S1207).

The terminal apparatus 200 subsequently determines whether the input receiver 211 has received input completion indication of an inspection result (step S1208). When the input receiver 211 has not received input completion indication of the inspection result in step S1208, the terminal apparatus 200 waits until the input of the inspection result is completed.

When the input receiver 211 has received an input completion indication of the inspection result in step S1208, the terminal apparatus 200 transmits the inspection result of the selected inspection pin to the server 300 (step S1209).

In the examples of FIGS. 11 and 12, the terminal apparatus 200 and the server 300 are online, so that the terminal apparatus 200 refers to the databases of the server 300 to execute processes. However, the embodiment is not limited to these examples.

For example, even if the terminal apparatus 200 is offline with the server 300, the terminal apparatus 200 may still be able to execute the processes illustrated in FIGS. 11 and 12 by downloading necessary information for the cyclic inspection or the individual inspection from the server 300 in advance.

When the location in which the inspection work is conducted is disconnected from the network, the terminal apparatus 200 and the server 300 are offline during the inspection work. In such a case, the terminal apparatus 200 causes the takeout part 217 to download data for use in the inspection from the server 300 in advance. The terminal apparatus 200 inputs the inspection result offline using the downloaded data, moves to a communicative environment, and then uploads the input inspection result to the server 300.

More specifically, the terminal apparatus 200 downloads data for use in the inspection online from the server 300, and the terminal apparatus 200 causes the communications status switching part 218 to switch the online communications status with the server 300 to the offline communications status. For example, the terminal apparatus 200 may display a screen for allowing the inspection worker to select one of the communications statuses between online and offline, and the communications status switching part 218 switches the selected one of the communications statuses determined by the inspection worker.

The terminal apparatus 200 assists offline the cyclic inspection or the individual inspection illustrated in FIG. 11 or FIG. 12 using the downloaded information, and receives input of the inspection result. Note that at this point, a transmission process of the inspection result in step S116 of FIG. 11 or step S1209 of FIG. 12 is not performed.

The inspection result input in the terminal apparatus 200 may be uploaded to the server 300 after the communications status between the terminal apparatus 200 and the server 300 is switched to online. The inspection result may be uploaded from the terminal apparatus 200 to the server 300 upon detection of switching the communications status between the terminal apparatus 200 and the server 300 to online.

When the server 300 of the embodiment receives a download request from the terminal apparatus 200, the server 300 controls whether to allow the terminal apparatus 200 to download information based on a type of the inspection to be conducted in the terminal apparatus 200. When the server 300 receives a download request from the terminal apparatus 200, the server 300 controls whether to allow the terminal apparatus 200 to download information based on a type of the inspection to be conducted in the terminal apparatus 200.

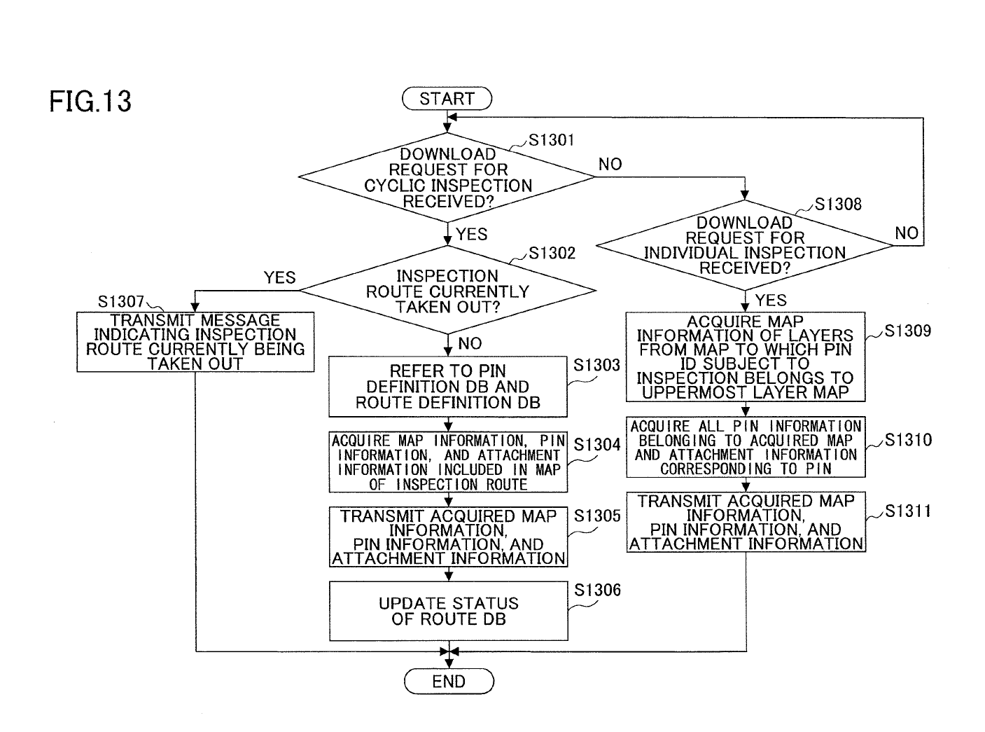

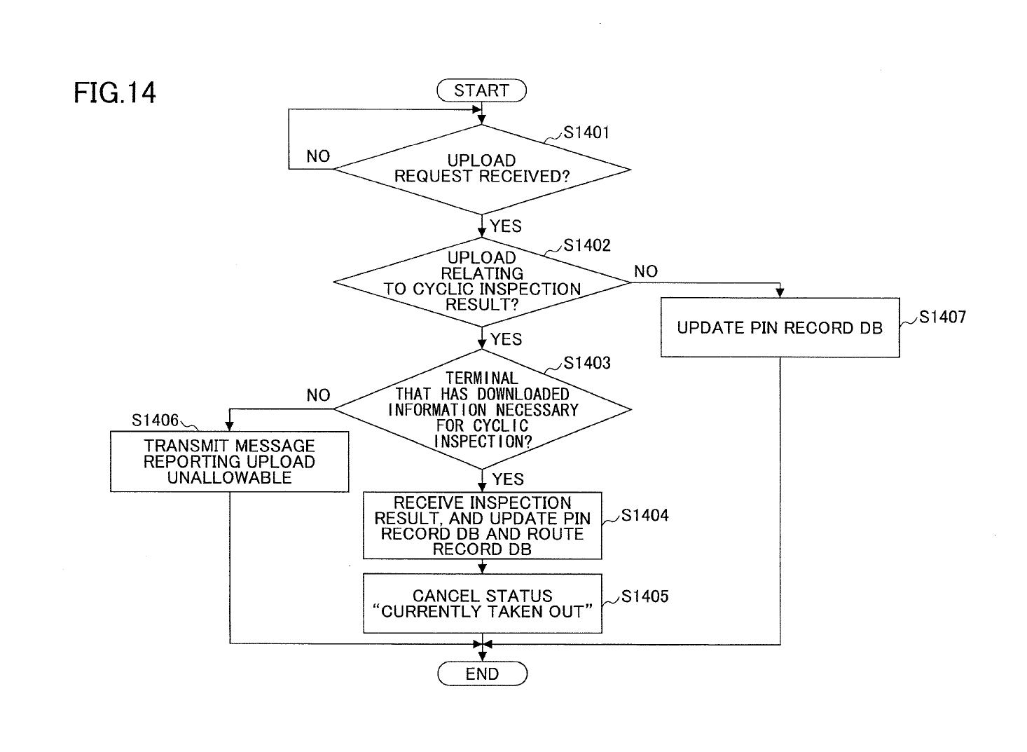

The following illustrates operations of the server 300 with reference to FIGS. 13 and 14. Initially, a description is given, with reference to FIG. 13, of a download process of downloading information from the server 300. FIG. 13 is a flowchart illustrating a download process from the server 300 to the terminal apparatus 200.

The server 300 of the embodiment causes the takeout controller 385 to determine whether the download request received from the input receiver 381 is a download request for downloading data for use in the cyclic inspection (step S1301). The download request for downloading data for use in the cyclic inspection may be transmitted from the terminal apparatus 200 to the server 300 when the inspection worker selects the cyclic inspection as a type of inspection and also selects an inspection route for conducting the cyclic inspection in the terminal apparatus 200. The server 300 determines whether the takeout controller 385 has acquired a route ID corresponding to the selected inspection route as a download request.

When the download request is not a download request for downloading data for use in the cyclic inspection in step S1301, the server 300 proceeds with step S1308 described later.

When the download request is the download request for downloading data for use in the cyclic inspection in step S1301, the takeout controller 385 refers to the route definition DB 330 to determine whether a takeout flag corresponding to the acquired route ID is “ON”, that is, whether the data for use in the cyclic inspection are currently taken out by any of the terminal apparatuses 200 (step S1302). That is, the takeout controller 385 determines whether the data necessary for the cyclic inspection of the received download request have already been downloaded.

When the takeout flag is not “ON”, that is, when the takeout flag is “OFF” indicating that the data for use in the cyclic inspection have not been downloaded by any of the terminal apparatuses 200, the takeout controller 385 refers to the pin definition DB 310 and the route definition DB 330 (step S1303). The takeout controller 385 subsequently acquires pin information corresponding to the pin ID included in the acquired route ID, map information corresponding to the map ID acquired from the pin information, and attachment information corresponding to the attachment ID acquire from the pin information (step S1304). The server 300 subsequently causes the cyclic inspection transmitter 382 to transmit the acquired pin information, map information, and attachment information to the terminal apparatus 200 (step S1305).

The server 300 subsequently causes the flag manager 384 to turn “ON” the takeout flag corresponding to the route ID acquired together with the download request in the route definition DB 330 (step S1306), and then ends the process.

When the takeout flag is turned “ON” in step S1302; that is, when the data for use in the cyclic inspection are currently taken out by any of the terminal apparatuses 200 in step S1302, the takeout controller 385 transmits a message indicating that the data for use in the cyclic inspection for the selected inspection route are not available for downloading (step S1307), and then ends the process. Note that the terminal apparatus 200 subsequently receives the message and displays the message.

When the download request is not a download request for the data for use in the cyclic inspection in step S1301, the server 300 causes the takeout controller 385 to determine whether the download request is a download request for the data for use in the individual inspection (step S1308). The download request for downloading data for use in the individual inspection may be transmitted from the terminal apparatus 200 to the server 300 when the inspection worker selects the individual inspection as a type of inspection and also selects a pin subject to individual inspection in the terminal apparatus 200. The server 300 determines whether the takeout controller 385 has acquired a pin ID corresponding to the selected pin as a download request.

When the download request is not a download request for downloading data for use in the individual inspection in step S1308, the server 300 returns to step S1301.

When the download request is a download request for downloading data for use in the individual inspection, the takeout controller 385 refers to the pin definition DB 310 to acquire the map ID of the map to which the acquired pin ID belongs. The takeout controller 385 subsequently acquires map information including all the layers from the map corresponding to the map ID to the uppermost layer map of the map (step S1309).

The takeout controller 385 subsequently acquires pin information of all the layers of the maps indicated by all the map information acquired in step S1309 and the attachment information corresponding to all the pins (step S1310). More specifically, the takeout controller 385 acquires the map IDs from all the map information acquired in step S1309. The takeout controller 385 then extracts pin information included in all the acquired map IDs or the maps to which the acquired map IDs belong. The takeout controller 385 subsequently acquires attachment information corresponding to the attachment IDs included in the extracted pin information.

The server 300 subsequently causes the individual inspection transmitter 383 to transmit the information acquired in step S1310 (step S1311), and ends the process.

The download process in the server 300 according to the embodiment is conducted as described above. When the server 300 of the embodiment receives the download request for downloading the data for use in the cyclic inspection, and the data for use in the cyclic inspection have already been downloaded by any of the terminal apparatuses 200, the server 300 will not download the corresponding data.

When the data for use in the individual inspection are included in the already downloaded data for use in the cyclic inspection, the server 300 of the embodiment allows the terminal apparatus to download the data for use in the individual inspection.

The above-described control will prevent two or more inspection workers from simultaneously performing the cyclic inspections on one inspection route while preventing the inspection workers from identifying the same pin to be subject to inspection in conducting the cyclic inspection. In addition, the individual inspection according to the embodiment allows two or more inspection workers to simultaneously perform inspection on the identical pin from different perspectives.

When the server 300 receives the download request for downloading the data for use in the individual inspection, the server 300 transmits to the terminal apparatus 200 map information including all the layers of the maps from the uppermost layer map to the layer map to which the pin subject to inspection belongs. This process may allow the inspection workers or the like to trace the pin subject to inspection in the order from the uppermost layer map to the layer map the pin subject to inspection belongs.

Next, an upload process of information with respect to the server 300 is described with reference to FIG. 14. FIG. 14 is a flowchart illustrating an upload process from the terminal apparatus 200 to the server 300.

The server 300 of the embodiment determines whether the input receiver 381 has received an upload request of the inspection result from the terminal apparatus 200 (step S1401). When the input receiver 381 has not received the upload request from the terminal apparatus 200 in step S1401, the server 300 repeats the process in step S1401.

When the input receiver 381 has received the upload request from the terminal apparatus 200 in step S1401, the server 300 causes the update controller 386 to determine whether the upload request is an upload request for uploading the inspection result of the cyclic inspection (step S1402). The upload request for uploading the inspection result of the cyclic inspection may, for example, be transmitted from the terminal apparatus 200 together with the route ID indicating the inspection route on which the inspection has been completed. When the update controller 386 has received an upload request for uploading the inspection result of the cyclic inspection, the update controller 386 receives the route ID.

When the upload request is an upload request for uploading the inspection result of the cyclic inspection in step S1402, the update controller 386 proceeds with step S1407 described later.

When the upload request is an upload request for uploading the inspection result of the cyclic inspection in step S1402, the server 300 causes the update controller 386 determine whether the terminal apparatus 200 that has transmitted the upload request matches the terminal apparatus 200 that has downloaded the data for use in the cyclic inspection corresponding to the inspection result (step S1403). That is, the server 300 determines whether the terminal apparatus 200 that has transmitted the upload request for uploading the inspection result of the cyclic inspection is the terminal apparatus that has initially downloaded the data for use in the cyclic inspection (i.e., the terminal apparatus designed to assist this cyclic inspection).

The following illustrates a process of specifying the terminal apparatus 200 in step S1403. In this embodiment, when the server 300 receives the download request associated with the cyclic inspection (step S1301 in FIG. 13) or the upload request (step S1401 in FIG. 14), the server 300 may receive or acquire the user ID of the terminal apparatus 200 into which the user (the inspection worker) has input when transmitting the download request or the upload request.

In this case, the server 300 may maintain the received user ID in association with the downloaded route ID. The user ID is identifier information specifying an inspection worker. The inspection worker may input the user ID together with a corresponding password to log into the update control system 100 of the embodiment.

The server 300 may specify the terminal apparatus 200 when the user ID received together with the upload request for the inspection result matches the user ID in association with the route ID.

Note that the information used for specifying the terminal apparatus 200 may be information other than the user ID of the inspection worker. More specifically, the information used for specifying the terminal apparatus 200 may, for example, be a terminal ID or the like capable of specifying the own terminal apparatus 200. Further, the information used for specifying the terminal apparatus 200 may be time information indicating a time at which the terminal apparatus 200 has transmitted the download request. In this case, the server 300 may maintain the downloaded route ID in association with the time information indicating the time at which the route ID has been downloaded. The terminal apparatus 200 maintains the time information indicating the time at which the route ID has been downloaded and transmits the route ID, and the time information processing apparatus to the server 300 when uploading the inspection result and the route ID. The server 300 may thus specify the corresponding terminal apparatus 200 when the time information that the server 300 maintains in association with the downloaded route ID matches the time information transmitted from the terminal apparatus 200.

When the server 300 specifies the corresponding terminal apparatus 200 in step S1403, the update controller 386 accepts the uploading of the inspection result from the terminal apparatus 200 (i.e., the update controller 386 allows the terminal apparatus 200 to upload the inspection result), and updates the pin record DB 320 and the route record DB 340 based on the data uploaded from the terminal apparatus 200 (step S1404). The server 300 subsequently causes the flag manager 384 to turn the takeout flag “OFF” corresponding to the record subject to processing in the route definition DB 330 (step S1405), and ends the process.

When the server 300 fails to specify the corresponding terminal apparatus 200 in step S1403, the server 300 causes the update controller 386 to transmit a message reporting that the uploading of the inspection result of the cyclic inspection is not available to the terminal apparatus 200 to allow the terminal apparatus 200 to display the message (step S1406).

When the upload request is not an upload request for uploading the inspection result of the cyclic inspection in step S1402, the server 300 causes the update controller 386 to determine that the upload request is an upload request for uploading the inspection result of the individual inspection. The upload request for uploading the inspection result of the individual inspection may, for example, be transmitted from the terminal apparatus 200 together with the pin ID indicating the pin on which the inspection has been completed. When the update controller 386 has received upload request for uploading the inspection result of the individual inspection, the update controller 386 receives the pin ID.

The server 300 subsequently allows the update controller 386 to receive the inspection result of the individual inspection to update the pin record DB 320 based on the data uploaded from the terminal apparatus 200 (step S1407), and the ends the process.

As described above, when the server 300 of the embodiment receives the upload request for the uploading inspection result of the cyclic inspection, and identifies that the terminal apparatus 200 that has transmitted the upload request matches the terminal apparatus 200 that has conducted the cyclic inspection, the server 300 allows the matched terminal apparatus 200 to upload the inspection result.

Accordingly in the embodiment, it may be possible to prevent the server 300 from receiving update requests for updating the inspection results for one cyclic inspection from two or more inspection workers.

The server 300 of the embodiment may accept the uploading of the individual inspection (i.e., the server 300 may allow the terminal apparatus 200 to upload the inspection result of the individual inspection). According to the embodiment, when the selected pin that is subject to individual inspection is included in the inspection route of the cyclic inspection, the server 300 allows the terminal apparatus 200 to update the inspection result of the individual inspection.

According to the embodiment, when two or more inspection workers simultaneously perform inspection on the identical pin, the server 300 may receive updating of the inspection results from the two or more inspection workers.

As described above, it may be possible to update inspection results appropriately in the embodiment, in accordance with characteristics of the cyclic inspection and the individual inspection.

The following specifically illustrates downloading of information from the server 300 to the terminal apparatus 200 and uploading of information from the terminal apparatus 200 to the server 300 in accordance with the embodiment.

Initially, a description is given of downloading data for use in the cyclic inspection from the server 300 to the terminal apparatus 200.

For example, in this embodiment, it is assumed that the route ID “R0001” is selected via the terminal apparatus 200 as an inspection route on which the cyclic inspection is conducted. In this case, the server 300 turns the takeout flag “ON” corresponding to the route ID “R0001” in the route record DB 340 (see FIG. 4).

The server 300 subsequently causes the takeout controller 385 to acquire the pin ID “P0001” to the pin ID “P0004” in association with the route ID “R0001” to acquire pin information of the respective pin IDs. The server 300 causes the takeout controller 385 to acquire map belongings corresponding to the pin IDs or map IDs.

According to the pin definition DB 310 of FIG. 2, map belongings and map IDs corresponding to the pin ID “P0001” to the pin ID “P0004” are map IDs “M0001” and “M0002”. The takeout controller 385 thus acquires map information corresponding to the map IDs “M0001” and “M0002”.

According to the attachment DB 370, the attachment IDs corresponding to the in ID “P0001” to the pin ID “P0004” are the attachment IDs “TD01” and “TD02”. The takeout controller 385 thus acquires attachment information corresponding to the attachment IDs “TD01” and “TD02”.

The server 300 then transmits the map information and the attachment information to the terminal apparatus 200 to complete the downloading of the data for use in the cyclic inspection.

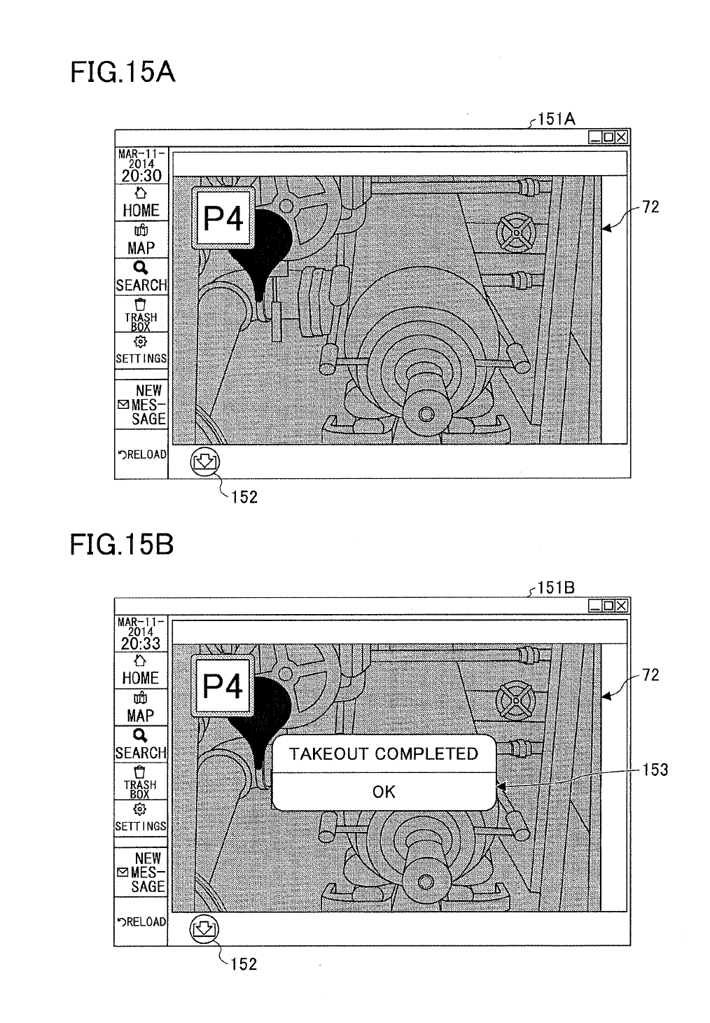

Next, a description is given of downloading data for use in the individual inspection from the terminal apparatus 200 to the server 300 with reference to FIGS. 15A and 15B.

FIGS. 15A and 15B are diagrams illustrating a download process from the server 300 to the terminal apparatus 200. FIG. 15A illustrates an example of a selection screen of the terminal apparatus 200 on which a pin is selected, and FIG. 15B illustrates an example of a screen of the terminal apparatus 200 that displays download completion of data for use in the individual inspection for the selected pin.

The selection screen 151A of the terminal apparatus 200 illustrated in FIG. 15A displays a map 72 to which the selected pin subject to individual inspection and a download button 152 for transmitting a download request to the server 300.

In the selection screen 151A, the inspection pin having the pin ID “P0004” is selected on the map 72.

When the user (inspection worker) presses the download button 152 in the above state of the selection screen 151A, the pin ID “P0004” and the download request are transmitted to the server 300.

The server 300 that has received the pin ID “P0004” determines that the download request corresponds to the individual inspection. The map to which the pin ID “P0004” belongs is the map having the map ID “M0002”. The server 300 thus acquires map information from the layer map having the map ID “M0002” to the uppermost layer map of the map having the map ID “M0002”

According to the pin definition DB 310 illustrated in FIG. 3, the uppermost layer map of the map having the map ID “M0002” is a map having a map ID “M0001”. The server 300 thus acquires map information corresponding to the map IDs “M0001” and “M0002”.

All the pin IDs belonging to the maps corresponding to the map IDs “M0001” and “M0002” are the pin IDs “P0000” to “P0005”. The server 300 thus acquires pin information corresponding to the pin IDs “P0000” to “P0005”.

The attachment IDs corresponding to the pin IDs “P0000” to “P0005” are the attachment IDs “TD01”, “TD02”, and “TD05”. The server 300 thus acquires attachment information corresponding to the attachment IDs “TD01”, “TD02”, and “TD05”.

The server 300 then transmits to the terminal apparatus 200 the pin information corresponding to the pin IDs “P0000” to “P0005”, map information corresponding to the map IDs “M0001” and “M0002”, and the attachment information corresponding to the attachment IDs “TD01”, “TD02”, and “TD05” as the data for use in the individual inspection.

When the transmission has been completed, the server 300 causes the terminal apparatus 200 to display a message illustrated in FIG. 15B.

According to the embodiment, information relating to the map to which the selected pin subject to inspection and the upper map of this map may be acquired. Hence, even when the terminal apparatus 200 and the server 300 are offline, the pin subject to inspection may be traced from the uppermost map in the terminal apparatus 200.

Next, a description is given of uploading the inspection result from the terminal apparatus 200 to the server 300.

The process of receiving the upload request for the inspection result of the cyclic inspection in the server 300 according to the embodiment is already illustrated with reference to FIG. 14. According to the embodiment, when the server 300 has allowed the terminal apparatus 200 to update the inspection result of the cyclic inspection, the inspection result is stored in the route record DB 340.

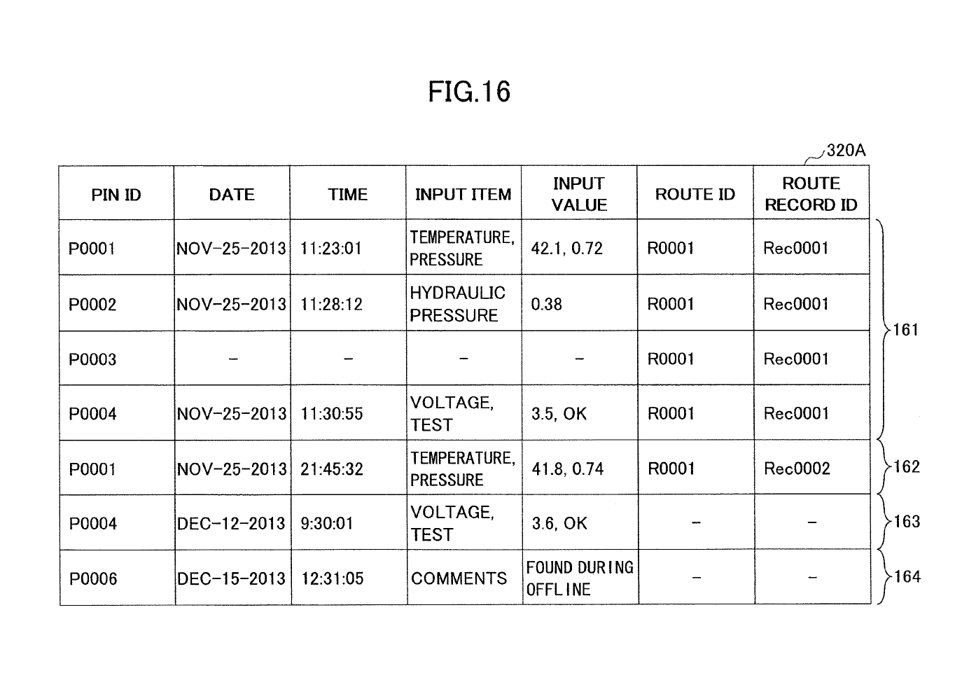

Next, a description is given of a process when the upload request for uploading the inspection result of the individual inspection with reference to FIG. 16.

The server 300 of the embodiment that has received the inspection result of the individual inspection assigns null values to the route ID and to the route record ID corresponding to the pin ID, and updates values of the other items excluding the route ID and the route record ID in the pin record DB 320.

FIG. 16 is a diagram illustrating an example of the pin record database (DB) 320A. In the pin record DB 320A illustrated in FIG. 16, pin record information 161 corresponding to the pin IDs “P0001” to “P0004” includes “R0001” as a value of the route ID and “Rec0001” as a value of the route record ID. The pin record information 161 is thus identified as an inspection result of the cyclic inspection in connection with the inspection route having a route ID “R0001”.

Similarly, the pin record information 162 is identified as an inspection result of the cyclic inspection in connection with an inspection route having the route ID “R0002”.

By contrast, in the pin record information 163, the route ID and the route record ID corresponding to the pin ID “P0004” have null values. Similarly, in the pin record information 164, the route ID and the route record ID corresponding to the pin ID “P0006” have null values.

Accordingly, the pin record information 163 and the pin record information 164 are recorded as information having the inspection results of the individual inspections independently conducted from the cyclic inspections.

According to the embodiment, it may be possible to store the inspection result of the cyclic inspection and the inspection result of the individual inspection that are managed separately with respect to one identical pin by maintaining pin record information.

Next, an illustration is given of a process of adding a new inspection pin in relation to the upload process from the terminal apparatus 200 to the server 300.

This embodiment may, for example, enable adding of a new inspection pin even in a case where the terminal apparatus 200 and the server 300 are in an offline status.

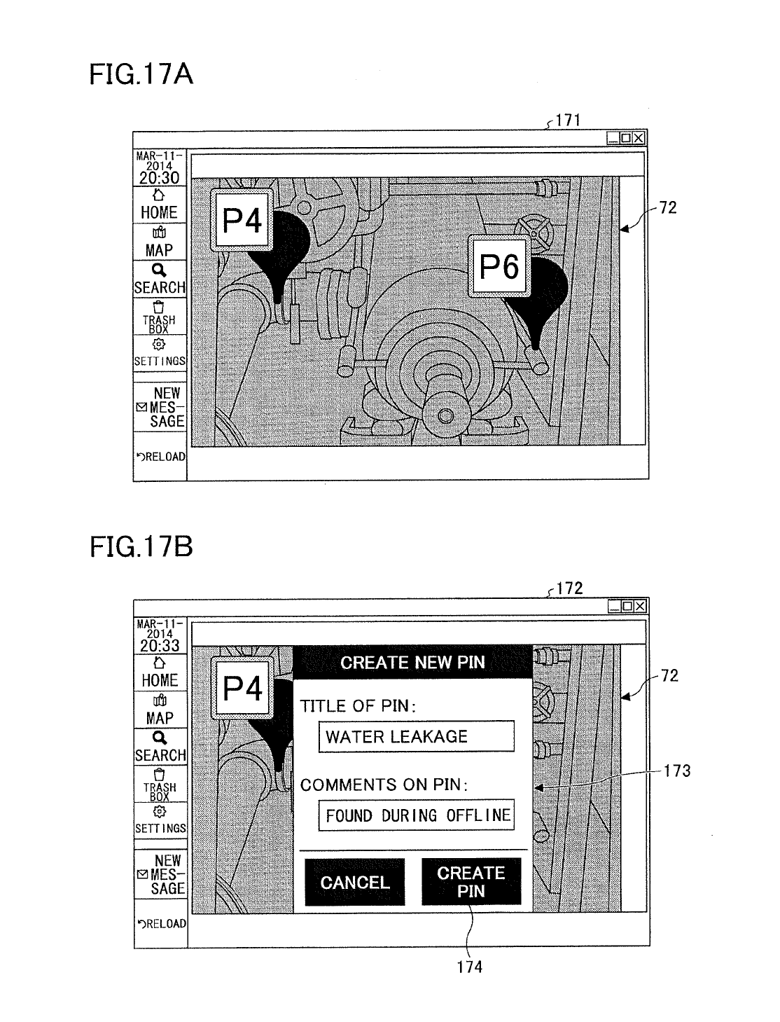

FIGS. 17A and 17B are diagrams illustrating adding a new pin in the embodiment. FIG. 17A illustrates an example of a screen of an added part selected for a new inspection pin, FIG. 17B illustrates an example of a screen for use in instructing to create the new inspection pin.

In this embodiment, it is assumed to add a new inspection pin when a location is newly found to be necessary for inspection during the inspection.

FIG. 17A illustrates a screen 171 illustrating a new pin P6 selected as a new inspection location on the map 72 to which the inspection pin P4 belongs. The selection of the pin P6 may be implemented by performing an operation such as pressing or touching a part on the map 72 as a desired setting part of the pin P6.

FIG. 17B illustrates a screen 172 displaying an entry field 173 for the user (e.g., the inspection worker) to input information to be upload to the server 300 as an inspection result of the pin P6, and an instruction button 174 for the user to give an instruction to create the pin P6. In this embodiment, the clock oscillator 172 may be displayed after the location to which the newly adding pin is selected. The entry field 173 includes items such as initial input items set in advance.

The terminal apparatus 200 may transmit an upload request for uploading in information of the pin P6 to the server 300 when the input operation to the entry field 173 and an operation of the instruction button 174 have been completed.

When the server 300 receives an upload request for uploading new pin information, the server 300 stores the pin information of the pin P6 into the pin record DB 320, in a manner similar to the inspection result of the individual inspection. Specifically, when the server 300 receives an upload request for uploading new pin information, the server 300 stores the pin information of the pin P6 as pin record information 164 into the pin record DB 320A.

Note that a new inspection pin may be added in a manner similar to the inspection result of the individual inspection even when the new inspection pin is added during the cyclic inspection.

The technology disclosed above is not limited to the examples or embodiments specifically disclosed above. Various modifications or alteration may be made without departing from the scope of the claims of the present invention.

The above-described process may be implemented by functional components of a computer, steps executed by the computer, or a recording medium storing a program executing the process.

According to the disclosed embodiments, it may be possible to control updating of the inspection results in accordance with on-site operations.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. An inspection result update control method comprising:
performing control to accept updating an inspection result of an inspection subject included in an inspection set from a first terminal that has initially downloaded data for use in inputting inspection results of the inspection set, the inspection set including a plurality of inspection subjects, and performing control to restrict updating an inspection result of the inspection subject from a second terminal when the data for use in inputting the inspection results of the inspection set including the plurality of the inspection subjects are downloaded, the plurality of inspection subjects being inspected in a predefined inspection order; and
performing control to accept updating an individual inspection result of an individual inspection subject included in individual inspection subjects from the first terminal that has initially downloaded data for use in inputting individual inspection results of the individual inspection subjects, as well as accepting updating an individual inspection result of the individual inspection subject included in the individual inspection subjects from the second terminal when data for use in inputting the individual inspection results of the individual inspection subjects are downloaded.

2. The inspection result update control method as claimed in claim 1, further comprising;
performing control to restrict the downloading of data for use in inputting the inspection results of the inspection set when a download request for downloading data for use in inputting the inspection results of the inspection set is received from the second terminal differing from the first terminal that has initially downloaded data for use in inputting the inspection result of the inspection set; and
performing control to allow the downloading of data for use in inputting the individual inspection results of the individual inspection subjects when a download request for downloading the data for use in inputting the individual inspection results of the individual inspection subjects is received from the second terminal differing from the first terminal that has initially downloaded the data for use in inputting the individual inspection results of the individual inspection subjects.

3. The inspection result update control method as claimed in claim 1, further comprising:
transmitting to the second terminal map information including layer maps from a layer map to which the pin subject to the individual inspection belongs to an uppermost layer map of the layer map, and inspection subject information in association with all the inspection subjects belonging to the layer maps when the download request for downloading the data for use in inputting the individual inspection results of the inspection subjects is received from the second terminal.

4. An inspection result storage control method comprising:
performing control to store first update information and second update information separately in a storage, the first update information being updated by sequentially inputting inspection results of a plurality of inspection subjects included an inspection set in a predefined inspection order, the second update information being updated by individually inputting individual inspection results of individual inspection subjects in an inspection order independent of the predefined inspection order.

5. A non-transitory computer-readable storage medium having stored therein an inspection result update control program for causing a computer to execute a process, the process comprising:
performing control to accept updating an inspection result of an inspection subject included in an inspection set from a first terminal that has initially downloaded data for use in inputting inspection results of the inspection set, the inspection set including a plurality of inspection subjects, and performing control to restrict updating an inspection result of the inspection subject from a second terminal when the data for use in inputting the inspection results of the inspection set including the plurality of the inspection subjects are downloaded, the plurality of inspection subjects being inspected in a predefined inspection order; and
performing control to accept updating an individual inspection result of an individual inspection subject included in individual inspection subjects from the first terminal that has initially downloaded data for use in inputting individual inspection results of the individual inspection subjects, as well as accepting updating an individual inspection result of the individual inspection subject included in the individual inspection subjects from the second terminal when data for use in inputting the individual inspection results of the individual inspection subjects are downloaded.

6. A non-transitory computer-readable storage medium having stored therein a storage control program for causing a computer to execute a process, the process comprising:
performing control to store first update information and second update information separately in a storage of the memory, the first update information being updated by sequentially inputting inspection results of a plurality of inspection subjects included an inspection set in a predefined inspection order, the second update information being updated by individually inputting individual inspection results of individual inspection subjects in an inspection order independent of the predefined inspection order.

7. An inspection result update control system comprising:
a terminal apparatus for use in facility inspection; and
an information processing apparatus configured to control updating of an inspection result input from the terminal apparatus,
the information processing apparatus having a memory and one or more processors configured to perform a process, the process including
performing control to accept updating an inspection result of an inspection subject included in an inspection set from a first terminal that has initially downloaded data for use in inputting inspection results of the inspection set, the inspection set including a plurality of inspection subjects, and performing control to restrict updating an inspection result of the inspection subject from a second terminal when the data for use in inputting the inspection results of the inspection set including the plurality of the inspection subjects are downloaded, the plurality of inspection subjects being inspected in a predefined inspection order; and
performing control to accept updating an individual inspection result of an individual inspection subject included in individual inspection subjects from the first terminal that has initially downloaded data for use in inputting individual inspection results of the individual inspection subjects, as well as accepting updating an individual inspection result of the individual inspection subject included in the individual inspection subjects from the second terminal when data for use in inputting the individual inspection results of the individual inspection subjects are downloaded.

8. An inspection result storage control system comprising:
a terminal apparatus for use in facility inspection; and
an information processing apparatus configured to control updating an inspection result input from the terminal apparatus,
the information processing apparatus having a memory and one or more processors configured to perform a process, the process including
performing control to store first update information and second update information separately in a storage of the memory, the first update information being updated by sequentially inputting inspection results of a plurality of inspection subjects included an inspection set in a predefined inspection order, the second update information being updated by individually inputting individual inspection results of individual inspection subjects in an inspection order independent of the predefined inspection order.
